(19) United States
(12) Patent Application Publication
(10) Pub. No.: US 2014/0263831 A1
(43) Pub. Date: Sep. 18, 2014

(54) Cross-wing Twin-Fuselage Aircraft

(71) Applicant: Lawrence C. Mitchell, JR., Yarrow Point, WA (US)

(72) Inventor: Lawrence C. Mitchell, JR., Yarrow Point, WA (US)

(21) Appl. No.: 13/800,975

(22) Filed: Mar. 13, 2013

(51) Int. Cl. B64C 39/04; B64D 11/00; B64D 27/12

(52) U.S. Cl. CPC B64C 39/04; B64D 27/12; B64D 11/00
USPC 244/1 N

(57) ABSTRACT

A dimensionally size-efficient aircraft being of a twin-fuselage configuration that addresses long-range high-capacity passenger commercial or military application needs, unique in that propelling engines (two, three, or four engine arrangements) are centrally mounted aft of a central cross-wing section, that section addressing the structural requirements of fuselage attachment with a means of passage between fuselages, the outer main wings being free from hanging appendages, thereby enabling efficient aerodynamic-lift wing design, the configuration using a split stabilizer and a split vertical tail for stable aerodynamic control. Engine locations are biased high and aft with the central and outer wings providing ground noise abatement while in flight, passenger cabin noise low due to aft engine locations.

Efficiencies of operation derive from: 1) a low overall weight/revenue seat ratio, 2) large and adaptable passenger floor plans, 3) compatibility with existing ground terminal facilities, 4) multiple engine configuration selections enabled by this aircraft layout, both turbo-fan and turbo-prop, and 5) opportunities of growth within this configuration. It is a low wave-drag configuration that better approaches the cross-sectional frontal-area shape ideal for minimum drag at near transonic speeds. This disclosure represents a general design concept and not a specific point design.

### CROSS-REFERENCE TO RELATED APPLICATIONS

Do not Apply

### REFERENCES CITED

US Patent documents

| | | |
|---|---|---|
| 6,913,228 | Jul. 05, 2005 | Lee et. Al. |
| 7,900,865 | Mar. 08, 2011 | Moore et. Al. |
| 8,157,204 | Apr. 12, 2012 | Wilby |
| 7,419,120 | Sep. 12, 2008 | Armand |
| 6,851,650 | Feb. 08, 2005 | Sankrithi |
| 6,666,406 | Dec. 13, 2003 | Sankrithi |
| 6,592,073 | Jul. 15, 2003 | Meekins |
| 6,047,923 | Apr. 11, 2000 | Lafferty |
| 5,893,535 | Apr. 13, 1999 | Hawley |
| 4,165,058 | Aug. 21, 1979 | Whitener |
| 3,913,871 | Oct. 21, 1975 | Miller |
| 3,907,218 | Sep. 23, 1975 | Miller |

### BACKGROUND OF THE INVENTION

Air traffic model forecasts suggest there is need for large capacity commercial aircraft to meet future air travel needs. Aircraft manufacturers already are in process of envisioning and designing new aircraft, and researching enabling technologies to meet anticipated demands. The largest of such aircraft now in service, are compromised in design by limits of ground facilities able to handle them. Such aircraft are also placing strain on the technologies of propulsion, structural design, and materials. Restrictions in place limit maximum wingspan and maximum weight for these aircraft. New blended-wing aircraft are now being researched for the eventual replacement of tube-wing aircraft design, but they present their own set of design issues, highest priority being how to solve safely cabin pressurization requirements and assure proper performance stability margins as a commercial aircraft. Blended-wing designs have efficiency advantages over traditional tube-wing designs of today, but are a further down-line solution, and may not be viable in time to meet nearer term needs.

This disclosure aircraft represents a transition design, based on proven technologies of today's aircraft, and offers a paradigm shift to a twin-fuselage tube-wing design concept, thereby retaining traditional pressurization solutions present tube/wing designs offer. This two fuselage design doubles the seating capacity of the newest non-jumbo jet, rivals jumbo-jet capacity, with considerably more efficient dimensions, lesser wingspan, and reduced length and height. Further, growth within a family of aircraft based on the twin-fuselage configuration of this disclosure may surpass mega-transport seat capabilities.

### BRIEF SUMMARY OF THE INVENTION

The disclosure aircraft (10) describes an aircraft of significant physical size designed to carry hundreds of passengers at a maximum range greater than 8000 nautical miles. It is dimensionally smaller than today's jumbo-jet designs and therefore very amenable to all world airports able to service these largest of commercial airliners. Unique to this design is the twin-fuselage tubular-wing configuration joined by a cross-wing structure that contributes lift and provides a passage means to allow movement from one fuselage to the other.

The fuselage is envisioned to be able to accommodate 9-abreast seating in a double row coach class. Each fuselage is typically able to seat 230 to 300 passengers in multiple-class arrangements.

### BRIEF DESCRIPTION OF THE SEVERAL VIEWS OF THE DRAWING

The aircraft of this disclosure (10) is described by 21 figures and one table and represent the configuration basis for the claims made. The disclosure aircraft (10) is estimated to be compatible with specification presented in Table #1; all other performance assumptions are based on this specification for the disclosure aircraft. The specifications of Table #1 are for the purpose only of giving further understanding as to the general size and weight of the disclosure aircraft, and these specifications do not represent a singular point design to which the claims presented herein only apply.

Below is a summary of the figure specifics.

FIG. 1 is an isometric view of a Cross-Wing Twin-Fuselage Aircraft (10), the name given to the disclosure aircraft, in take-off mode, the Isometric view looking from above.

FIG. 2 is an isometric view of the Cross-Wing Twin-Fuselage Aircraft (10) in take-off mode, the view looking from below.

FIG. 3 is the same aircraft (10) in an isometric view, the aircraft being in final approach as seen from below just as the aircraft has passed.

FIGS. 4, 5, and 6 show a top plan view, a side view, and a frontal view respectively for the Cross-Wing Twin-Fuselage Aircraft (10).

FIG. 7 shows typical main deck seating and service accommodations, 9-abreast seating for coach (48) and 6 to 8 abreast seating for other classes (first class (46) and business class (47)). The figure suggests a 3-class capacity of 538 passengers or more. Typical locations for lavatories (59) and galleys (58) are also shown.

FIG. 8 shows the fuselage under-belly allocations below the main deck and points out the main cross-wing structure (51), the structural tie for the engines (52), the location of fuel tanks (32,33,41,42,43), holds for cargo (34), forward (21) and main landing gear (23) stowage, buoyancy holds (61), crew rest areas (63), an on-board lounge (49), stairways to the lounges (37), the passage between the fuselages (36), and the aft fuselage bulkheads (62).

FIGS. 9, 10, and 11, show examples of turbo-fan jet engine installations (29) located just rear of the central cross-wing section as it connects the twin fuselages together.

FIG. 12 shows that the disclosure aircraft (10) is compatible with other propulsion techniques, that shown is with prop-prop engines (55) and contra-rotating propellers (56).

FIG. 13 shows a design variant using a v-tail (53-54) configuration.

FIG. 14 shows capabilities for three different aircraft design approaches, comparing today's aircraft (aircraft #1-#5), with the disclosure aircraft design, and blended wing expectation, design capability bands, plotted in terms of the overarching efficiency factor (Maximum take-off weight including payload and fuel/revenue seat).

FIG. 15 shows the center-of-gravity movement referenced to the center-of-lift for several flight and payload conditions as function of the disclosure aircraft weight.

FIG. 16 shows state-of-the-art fuselage and total aircraft wetted areas, a factor affecting drag, and the point design wetted areas for the disclosure aircraft, plotted as a function of maximum take-off weight.

FIG. 17 shows typical commercial aircraft frontal area and how it increases with aircraft seating capacity, showing also the frontal area of this disclosure aircraft (10) to be within a reasonable design scatter band.

FIG. 18 shows the similar frontal areas but referenced to aircraft weight at liftoff.

FIG. 19 shows the cross-sectional area presented to the atmospheric ether of a typical jumbo-jet of current design, at nose-to-tail stations, compared to the smooth ideal suggested by the area-rule for least wave drag.

FIG. 20 shows the same information as FIG. 19, but for the cross-wing twin-fuselage aircraft of this disclosure (10).

FIG. 21 shows the disclosure aircraft (10) plane of symmetry (57) and that mature design can effectively take advantage of a lowered drag coefficient as is the case for catamaran design, by self-canceling a portion of the wave drag.

Each figure shows identification number callouts of the disclosure aircraft assembly or feature, and are here summarized for reference:

ID #: Cross-wing Twin-Fuselage aircraft of this disclosure (10); Right-Fuselage (nose-section with pilot deck) (11); Right-fuselage (main central section) (12); Right-fuselage (Rear-section) (13); Right-Main wing (14); Left-Fuselage (nose-section) (15); Left-fuselage (main central section) (16); Left-fuselage (Rear-section) (17); Left-Main wing (18); Central Cross-wing (19); Unassigned (20).

ID #: Forward-Landing-Gear dual-wheel [Steered] (2) (21); Forward-Landing-Gear Cowling bubble (one/fuselage) (22); Main-Landing-Gear triple bogey-wheel (2) (23); Main-Landing-Gear Cowling bubble (one/fuselage) (24); Split-Stabilizer (2) one/fuselage (25); Split-Vertical-tail (2) one/fuselage (26); Right vortex-control Winglet (27); Left vortex-control Winglet (28); Turbo-fan engine with Nacelle (3) (29); Unassigned (30).

ID #: Central Wing-box structure containing personnel passage (31); Right wing fuel tank (32); Left wing fuel tank (33); Cargo containers (14 per Fuselage) (34); APU (35); Personnel passage tunnel in cross-wing box (36); Stairways (37); Fuselage cowling for reduced drag [helps approach area rule] (38); Anti-shock pods (not to scale) and for cross-sectional smoothing and housing of flap mechanicals (39); Unassigned (40).

ID #: Forward cross-wing fuel tank (41); Middle cross-wing fuel tank (42); Aft cross-wing fuel tank (43); Forward main-deck access door (44); Middle main-deck access door (45); First-class seating section (46); Business-class seating section (47); Coach-class seating section (48); On-board lounge (49); Unassigned (50).

ID #: Wing-box structural reinforcement housing main-landing-gear, (51); Aft tie-structure for engine (52); Right-fuselage V-tail (53); Left-fuselage V-tail (54); Turbo-prop engine (55); Contra-rotating propeller pair (56); and Longitudinal Plane-of-Symmetry (57); Galleys (58); Lavatories (59); Unassigned (60).

ID #: Buoyancy holds (61); Aft-fuselage pressurization bulkhead (62); Crew rest area (63).

### DETAILED DESCRIPTION OF THE INVENTION

The aircraft (10) of this disclosure is presented with isometric views FIGS. 1-3, plan-views FIGS. 4-6, and cut-away detail views FIGS. 7-8.

Fuselage

The description of the fuselage concept is to show how very similar it is to the fuselage designs of the commercial airlines of today.

The fuselage of the disclosure aircraft (10) is just over 200 ft in length. The main deck provides seating accommodations for passengers and services FIG. 7. It is anticipated that passenger loading can be accommodated through two forward entrances (44,45) for each fuselage.

One of the twin fuselages, left or right, in the nose section (11 or 15) will contain the pilot cockpit cabin, equipped as other commercial aircraft, but with additional displays for scene visibility masked by the fuselage twin nose section, so viewing from the chosen cockpit need not compromised. The other fuselage nose section is available to provide passenger amenities, as airlines would so choose.

The forward under-belly section FIG. 8 of each fuselage (12,16) provides for container/palletized cargo (34). Just in front of this cargo hold is stowage volume for the forward steering landing gear (21) and avionics. A cargo door opening to the cargo hold would be positioned just aft of the forward landing gear. Moving further aft in the fuselage belly are passenger lounges (49) stairs (39), passage tunnel entrance (36) for connection and passage between the twin fuselages, then crew rest areas (63)—servicing also as medical centers. The wing box (51) follows. Aft of the wing box (51) are the main landing gear (23) stowage volumes, the main landing gear (23) being a triplet-paired wheel bogey, simply hinged inward and down for landing. Behind the main landing gear is the engine tie structure (52) a reinforcement bridging structure for support of the fuselage-mounted engines (29), then additional cargo holds. As shown in the figures, each twin-fuselage is a near-mirror image of its twin. The fuselage is to be designed and manufactured in accordance with accepted practice of today.

There are no tricks for cabin pressurization. All but the tail section of each fuselage is pressurized forward of a rear bulkhead (62) at the aft end of the passenger cabin. Exceptions to this pressurized section description are the under-belly sections containing the landing gear. In the under-belly section surrounding the main landing gear (23), additional structure (52) supplements the generically designed fuselage sections (12,16) for landing gear support transitions, and for structure necessary to support the engines (29). Pressurization safety margins in these holds can and will be achieved without difficulty.

Behind the main fuselage rear bulkhead (62) are tapered fuselage transitions (13,17) supporting vertical tail (26) and stabilizer (25) interfaces. At the most aft station of one fuselage is location for an auxiliary power unit [APU] (35) as is presently accepted practice. The fuselage rear transitions (13,17) are biased high allowing for takeoff angles-of-attack and may include cowling to reduce drag, i.e. to improve area-rule cross-sectional smoothness.

Along the inner side of the under belly, localized bulging of the outer-skin is used to provide necessary envelope for housing stowed landing gear. Further, transitional flaring cowled volumes (38) are added at and before the outer-wing (14,18) root interface to smooth the increasing area presented to the atmospheric ether. It is not by design that the fuselage will act to provide any lifting force at a zero angle-of-attack. The fuselage will add lift for positive angles-of-attack.

Preliminary analyses of the complete aircraft indicate that localized flared cowling volumes (38) at the fuselage—outer wing aerodynamic transition act to minimize overall near-sonic drag, the localized bulging effecting a smoother transition of the increasing and decreasing station equivalent frontal areas, criteria's suggested by area cross-sectional rules for minimum drag. Typical fuselage bulging (38) are as shown and act also to provide cowling at the fuselage wing and central cross-wing interfaces, and aid in providing additional stowage volume for the main landing gear. The bulging (38) shown is typical of what may be beneficial, though to exactly define the optimum of outer-wing fuselage transition, wind tunnel data is necessary.

Aft Engine Mounting

The aft mounted engines (29) make the aircraft a pusher design, i.e. the thrust vector is behind and in this case above the aircraft center-of-gravity. The engine thrust vector develops a nose-down moment about this center-of-gravity, fully compensated by tail stabilizer design (25). The moment helps in overall aircraft stability allowing the center-of-lift [CL] to be near to the center-of-gravity [CG] without stability margin issues. The engine compliment (29) mounts aft on the fuselage, thus eliminating outer-wing hanging appendages that effect overall wing lifting capability, thus providing a greater outer-wing lift coefficient due to elimination of usual wing-engine pylon and exhaust-flap issues. This means less drag, particularly in the critical take-off climb phase, less asymmetric yaw in event of engine-failure since engines are near to the aircraft centerline, and allows shorter landing gear, air-stair, and exit-slide lengths. The engines mount together on a single bridging structure (51), without need for pylons, this structure (51), attaches to each fuselage just under the main decks, meaning a close structural connection to fuselage reinforced structure required for the main landing gear and the central wing box connection. This arrangement means efficient weight design, opportunity for engine-noise isolation, and reduced cabin vibration than for pylon mounted fuselage engines commonly seen in today's in-service aircraft.

More benefits of this engine configuration for the disclosure aircraft (10), are listed below:

1) Engine thrust torque allows for full stability even if the lift center-of-pressure were to move slightly forward of aircraft center-of-gravity;
2) Throttle back-off will cause the nose to rise in the opposite direction afforded by wing flap extension, thereby achieving lower approach and landing speed;
3) For takeoff and landing, angle-of-attacks can be lower;
4) Engines work to reduce stall tendency;
5) Engine services concentrated within local engine area, not wing-to-wing for reduced weight.
6) Aft fuselage-engine-mounts are safer in event of a ditch scenario in that the engines (29) and outer wings (14,18) are not susceptible to tear-off.

Engine Nesting

Turbo-fan engine configurations (29) for the cross-wing twin-fuselage aircraft (10) are numerous. For each configuration, engines mounted high and aft of the central wing means engine noise radiates up and away from the ground while in flight (Under wing designs reflect noise off the wing bottom and toward the ground). Three concepts are shown in this disclosure, 2, 3 and 4 engine layouts.

1) A two-engine design FIG. 10, each engine mounted high on the single bridging structure (52), just aft of the cross-wing, engine thrust determined by the aircraft requirements.
2) A three-engine configuration FIG. 11, [shown in most of the figures], the third engine mounted on the under side of the single bridging structure (52), the third engine centrally located on that structure. Aerodynamic trim can also be incorporated on this connecting member.
3) A four-engine compliment FIG. 12, a fourth engine mounting along side the under-side mounted engine of the three-engine configuration, thereby sharing that same bridging lower-fuselage connecting structure (52).

In each of the engine arrangements, the collective engine thrust force applies a nose down moment about the aircraft center-of-gravity [CG] in an additive fashion, as does the center-of-gravity of the aircraft, relative to the wing lift center-of-pressure [CP]. This means that the correcting stabilizer moment may be larger than with aircraft designs that mount the engines below the wings. Further, ample stability margins in pitch control are achieved with lesser CG/CP separation due to the moment direction provided by the high thrust position. All engines can be angled slightly up or down as determined by wind tunnel test results.

Central Cross-Wing

The central cross-wing structure (19) is designed to provide structural connection, bridging between the twin fuselages (11-13,15-17). This wing structure (19) provides about 25% of the total lift, its airfoil not designed for a maximum lift, as are the outer-main lifting wings (14,18). Its position and lift contribution relative to the main outer-wings is tailored for the fuselage design-length chosen. Further, enhanced ground effects will be present due to the central cross-wing section contributing to lower take-off and landing speeds; this lift also tailored to assist takeoff and landing stabilities. This wing section (19) is not pressurized, as are the fuselages (11-12,15-16), except for a tubular passage connection (36) that allows personnel movement between the fuselages. Aerodynamic functionalities could include laminar over-surface flow control, lift abatement capability, but is not expected to include flap or other active aerodynamic control surfaces. Wing-to-fuselage cowling (38) will be designed to minimize drag.

This wing section (19) also provides fuel tank volume for about half of the loaded fuel, that tankage being in the mid-to-rear portions of this wing section airfoil. Depending on specification of the user, forward portions of this wing section can house buoyancy holds to enhance floatability of the aircraft.

It is expected that the placement of an airfoil just in front of the engine compliment will have beneficial effects, for example, negative pressures caused by the engine intakes just behind the wing may increase laminar flow over the airfoil adding lifting efficiency for this wing section, and/or may help lower in-going air temperature seen by the engines, enhancing engine efficiencies at cruse. These are possibilities that the design suggests, but require test and detailed simulation to quantify.

Main Lifting Wings

Each of the main outer wings (14,18) is swept at about 35 degrees and carries the other half of the fuel load. The wing root is from the lower mid-section of the fuselage (12,16) and attaches to the main cross-wing box (51) connecting each wing (14,18) to each other. The mean chord of the main wings have a contour that provides a lift coefficient of >0.5, and a stall angle-of-attack characteristic of >15 degrees when combined with the central cross-wing structure (19). Vortex winglets (27,28) enhance the wing area lift effectiveness and manage wing vortex generation.

The wing root (38) is shaped to minimize fuselage/wing drag interactions. Wing softness (compliance) is integral to the outer wing design and is expected to eliminate cabin flight roughness. Leading edge design is of traditionally accepted standards. Wing flaps are utilized for landing, while wing ailerons and trim surfaces work to provide roll stability and pitch force trim. Note the disclosure aircraft roll moment-of-inertia is greater than comparable tube-wing aircraft of today. Ailerons sizing will be larger, but the disclosure aircraft will not be as susceptible to forces effecting roll.

Each of the main lifting outer-wings (14,18) may include anti-shock pods (39) (two per wing shown; not-to-scale) to improve the flow over the upper outer-wing surface, facilitate a smoother area profile presented to the slip-stream, and act as cover for flap extension mechanicals.

Stabilizer

The rear stabilizer (25) is of a split design, one-half attached to each fuselage rear cone section (13,17). The stabilizer is an airfoil designed to produce a negative lift force. The design is to be such that at altitude and cruse speed, overall aircraft drag will be lowest and in-flight control stability and margins are maintained. The stabilizer provides pitch control for take-off and counters wing-flap effects during approach and landing. There is nothing new or revolutionary as to the way the stabilizer is designed, or the way the disclosure aircraft will handle, except that no state-of-the-art fuel tank volume would be incorporated into the stabilizer.

Vertical Tail

A vertical tail (26) rises above each of the aft twin fuselages (13,17) as shown by the figures. Aircraft yaw control is the vertical tail function, just as with other aircraft. Benefits of this configuration are that the forces needed of the vertical tail are lower than for conventional aircraft of size. Crosswinds and engine out situations usually size the vertical tail area requirement. This configuration reduces fuselage cross-section exposure to crosswinds due to protections the wind-facing fuselage offers the leeward fuselage. Engine-out yaw moments are of much less magnitude due to the central location of the engines. Each vertical tail is expected to be less in area than the usual single tube/wing aircraft tail size, meaning the combined vertical tail surface area will be about half.

### Comparisons with State-Of-The-Art

Necessary to the viability of any proposed large aircraft is an assessment of design, state-of-the-art comparison, and analyses of factors affecting performance and range. It is shown that a twin-fuselage aircraft, like that of this disclosure (10) offers airlines and manufacturers a transition design option, even as they research ways to develop more efficient aircraft for the future. Measured in the promise of lowered aircraft weight per passenger revenue seat, much of today's technology centers on solving problems that will make a blended-wing aircraft feasible. Blended-wing design offers promise for much lower operational costs as shown in FIG. 14. The weight at takeoff per revenue seat is an excellent direct measure of operational cost per seat, the blended wing representing a solution approaching half the operating costs of today's aircraft. Blended-wing technology, however, is a way into the future. Needs today for greater capacity are pushing design to second deck transition solutions to add seat capacity, ground-facilities limiting aircraft footprint size increases. State-of-the-art double deck solutions seem necessary, a lighter weight two-fuselage approach just not being in view. However, the two-fuselage design offers a compelling alternative, equivalent capacity, lower weight, and less airport footprint at lower cost. The twin-fuselage approach incorporates and builds on now-available material and state-of-the-art engineering technologies for fuselage and wing design, taking full advantage of lightweight composite materials. It would seem that a twin-fuselage aircraft is an overlooked alternative until now.

FIG. 14 shows this directly. The overarching efficiency factor (Maximum take-off weight/revenue seat) compares today's aircraft (aircraft #1-#5) with the disclosure aircraft (10), and a blended wing design band of expectation. It is easily seen the disclosure aircraft occupies a transition efficiency space between aircraft of today and tomorrow's aircraft. The disclosure aircraft (10) offers a transition “halfway step”, a step that technology of today can support. FIG. 14 shows bands-of-design capabilities for the tube-wing aircraft designs of today, expected blended-wing aircraft design, and the gap band filled by the disclosure aircraft (10). As is seen, the disclosure aircraft (10) offers between 20% and 30% improvement in overall capability, based on the ratio parameter, take-off-weight/revenue seat. The comparison shown is for aircraft with a similar maximum range. None of this should is a surprise, except in the effectiveness of this transitional solution. It is in effect a paradigm shift that should and must be considered, for the needs of commercial aviation are here now, particularity needs for capacity increase at long range.

The cross-wing twin-fuselage is not a strange looking aircraft (10); rather it offers a pleasing profile, very much like an aircraft should look. It is not a radical departure from the aircraft of today. Two, three and four engine configurations are tradable options. Military transport configuration options abound. Development costs are expected to be reasonable for the potential gains offered by this configuration. Much of the design can be borrowed from today's aircraft. Fuselage cabin dimensions can be borrowed as well as engines and wing-compliant technologies.

This disclosure aircraft (10) should well be considered as evolutionary design, not revolutionary design, but its impact for increasing seat capacity within or lesser dimensions of today's jumbo jets is revolutionary, with much lowered seat costs/mile performance.

Here are a few more reasons why airlines and passengers should like this aircraft.

1) Passenger surroundings will feel familiar, not over crowded, and safe.
2) Usual percentage of window-isle seating retained.
3) Opportunity for creative use of “cockpit” space.
4) Seat capacity rivals the largest of jets with operating costs reduced by 20% to 25%.
5) Capable of nearly doubling seat revenue within today's accepted overall aircraft dimensions.
6) Serviceable from existing airport gates.
7) Passenger loading from up to four entrances.
8) Rear engine location makes for quiet cabins.
9) Will be noise-friendly near airports.

### Other Factors

The viability of large aircraft in this niche is pretty much determined by overall weight as discussed in the State-of-the-art comparisons paragraph above. Other factors of design related to the cross-wing twin-fuselage disclosure aircraft uniqueness are addressed below. Data results shown are from preliminary design assessments and comparative analyses of the disclosure aircraft with today's state-of-the-art commercial jumbo-jets, and was used to validate overall flight stability, drag estimates, and the expected benefit of the disclosure aircraft.

Control and Stability Characteristics

Stability safety margins for the disclosure aircraft are comparable with those of today's commercial aircraft. An analysis of center-of-gravity positions over a flight profile from takeoff through landing has been estimated to validate that controllability and stability are safely achieved. Results of the disclosure aircraft center-of-gravity movements are shown in FIG. 15, at varying flight conditions as a function of aircraft weight. For all cases examined, maximum takeoff gross weight (TOGW), three mid-flight weights, and for two landing weights, (maximum payload, and maximum range payload), the center-of-gravity always remains ahead of the lift center-of-pressure, within bounded limits equivalent to less 10% of the outer-wing average wing cord-length, well within accepted practice for controllability, stability, and safety, the analyses based on fuel tank loading and depletion management schedules.

The center-of-lift can and will also be controllable, within limits, in manners used by today's aircraft, including, but not limited to leading edge and flap extensions, spoilers, boundary-layer laminar-flow enhancement techniques, and angle-of-attack changes. Suffice to say, the aircraft of this disclosure will not be a difficult aircraft to fly.

Drag Factors and Characteristics.

Drag issues are discussed and compared with the current state-of-the-art aircraft. Parasitic drag factors are discussed in terms of the wetted, frontal area, and wave-drag.

Wetted Area

A two-fuselage solution at first seems to be an unnatural design. After all, two fuselages will lead to a greater fuselage wetted-surface area parasitic drag for an equivalent cross-sectional area single fuselage. The same logic applies for frontal area comparisons. So how can the disclosure aircraft compete with the single large equivalent cross-section fuselage approach? The answer is in the numbers, the design, and that induced drag is of near equal importance to parasitic drag magnitudes.

1) For equivalent seat capacity, the twin fuselage aircraft will always be substantially lighter in total weight than a single fuselage aircraft. (See FIG. 14). This means that the induced drag-component will also always be less.

2) Frontal fuselage cross-sectional areas of single and twin fuselage aircraft need not be the same for equivalent payload floor areas and/or seating capacities.

3) Wetted areas for an aircraft are more than just the fuselages. Wetted area must include the whole of the aircraft, wings and all. A larger parasitic drag-component does not disqualify an aircraft design in terms of overall efficiency.

FIG. 16 shows wetted area comparisons of aircraft in service today and the wetted areas for the disclosure aircraft, fuselage only and total. Fuselage wetted areas as shown are relatively large for the twin fuselage design, but the figure also shows wetted areas for the complete aircraft, inclusive of wings, stabilizer and vertical tail, wing-fuselage transitions, engine pylons, and nacelles; the total aircraft wetted area differences not being pronounced as they are when comparing fuselage-wetted areas only. In the end, what is first thought to be an overarching factor in determining overall drag is not, nor does it accurately predict drag effect considerations at the bottom line.

Frontal Area

Frontal areas of large aircraft are large indeed. Frontal area is a component of aircraft parasitic-drag; it affects thrust requirements and cruse speed. Frontal area is best presented as a parameter associated with aircraft seating capacity and/or overall aircraft weight. FIGS. 17 and 18 show these comparisons. The disclosure aircraft is within point design scatter of existing aircraft, and shows best when referenced to seat capacity. Twin fuselage frontal area falls well within acceptable ranges, particularly if based on seat capacity at max range FIG. 17. It is to be remembered that frontal area consideration is only one of several design parameters affecting parasitic drag. Aircraft can achieve lower total drag by addressing other factors as well, (lowered gross weight, adherence to area-rule shapes, and higher wing-aspect ratios), frontal area impacts thereby lessened.

The Wave-Drag Effects

The smoothness of the cross-sectional area change along an aircraft body length, nose-to-tail, helps to determine wave-drag magnitudes (a factor in determining the overall parasitic drag component) at cruise speeds, and surprisingly is largely independent of actual shape. Aircraft designs that approximate what is called the transonic area-rule, (an aerodynamic shape should change in cross-sectional area as smoothly as possible) approach the ideal shape for lowest parasitic drag at transonic speeds, particularly above Mach 0.75, this being a most important operating speed range for commercial aircraft. A “perfect” aerodynamic shape would roughly look like a fat cigar, pointed at both ends. FIG. 19 compares this ideal with the typical jumbo-jet used today and FIG. 20 is the same cross-sectional presentation for the cross-wing twin-fuselage aircraft of this disclosure. The figures show that though the average cross-sectional area presented to the atmospheric ether volume (frontal average areas are roughly similar), the disclosure aircraft more nearly approximates the ideal. This then should allow the disclosure aircraft to be characterized by a lower-than-expected overall drag coefficient, meaning higher cruse speed.

For the typical jumbo-jet presented in FIG. 19, the cross-section grows quickly, levels off, then grows rapidly as the wing-nacelle cross-sections present themselves, after that, then quickly fall to again quickly rise once more over the tail and stabilizer cross-sections. Transitions can be made somewhat smooth, but cannot be a good approximation of the also shown ideal shape profile.

In contrast, the profile for the disclosure aircraft much better approximates the shape ideal until such point that the engine nacelle cross-sections are accounted for, FIG. 20. The engine nacelle cross-sections represent the sudden rise, then fall-off just past mid-station. The much closer adherence to the area-rule achieved by the disclosure aircraft is expected to equate to a lowered coefficient-of-drag, meaning a lowered parasitic drag, and therefore an at least equivalent or higher overall cruse speed at the minimum drag point.

Catamaran Effects

There is another design consideration that the disclosure aircraft will benefit from, that being a “catamaran effect”, where facing fuselages develop wave-drag profiles that partially cancel, cancellation due to the opposing fuselage wave-drag fronts. FIG. 21 shows the longitudinal plane-of-symmetry where drag-waves will interact. These wave-drag interactions reduce left and right-directed drag wave propagations, by the right and left fuselages respectively, thereby effecting overall drag. Though not shown, each fuselage could be contour tailored, nose-to-tail, as would be seen in a top plan form view, shaped such that induced wave-drag of the inside left and right fuselages interact with greater wave-drag cancellation, the outward facing fuselage surfaces being less curved to the atmospheric ether, thereby reducing the outboard fuselage surface net contribution to the coefficient-of-drag.

### Detail Description Summary

The overall performance and operational benefits of this disclosure aircraft are clear. It is established that lowered seat operational costs are a fallout of this twin fuselage design. The disclosure aircraft provides significantly lower weight per seat-mile at maximum range, and though exhibiting a higher coefficient-of-drag, still promises 20 to 30% greater affordability than capabilities of today's single-fuselage aircraft. All technologies are here now, meaning acceptable risk and development cost. The disclosure aircraft fits into a niche airlines need, passengers will appreciate, and if developed will help to reduce overall energy expenditures by aircraft.

1. What I claim as my invention is a dimensionally efficient large long-range aircraft design being of a cross-wing twin-fuselage configuration, unique in that propelling engines (two, three, or four engine arrangements) are centrally mounted aft of a central cross-wing section, such section being both partial wing, fuel tanks, and structural connection for twin-fuselage attachments, inclusive with means-of-passage between fuselages, the outer main wings being free from hanging appendages, thereby enabling of efficient aerodynamic-lift wing design, such configuration utilizing both a split stabilizer and a split vertical tail, the full flight center-of-gravity profile adequately forward of wing lift-center, that lift-center, along with engine thrust, both contributing a nose down center-of-gravity moment, which is countered by a reverse lift airfoil stabilizer providing ample nose-up moment, thereby achieving flight safety margins with low drag for both normal and engine-out operations, said engine locations biased high and aft, so that the central cross-wing and outer wings provide ground noise abatement, passenger cabin noise minimized by aft engine installations.

2. What I claim as my invention is a dimensionally efficient large long-range aircraft of claim 1, but for a configuration with turbo-prop engines used to propel the aircraft in place of turbo-fan engines, turbo-prop engines turning contra-rotating propeller pairs, one or two such pairs acting along co-aligned longitudinal axes, the propeller pairs being of type and design to achieve high overall efficiency and speed.

3. What I claim as my invention is a dimensionally efficient large long-range aircraft of claim 1, inclusive of the wing-fuselage arrangement of cross-sectional frontal area increase and decrease, achieving a smoothed and tailored shape, specifically designed to closely approximate the transonic area-rule minimum-drag ideal, that shaping accomplished by the staggering of the central cross-wing forward and the outer-wings aft, bulging of the fuselage transition from fuselage to the outer wing forward root, and localized bulging in aft sections of the fuselages, the effect of such tailored and smooth cross-sectional area transitional shaping, nose-to-tail, achieving a lowered overall coefficient-of-drag, that lowered drag coefficient affecting a higher optimal speed achieved at the point of minimum required thrust.

4. What I claim as my invention is a dimensionally efficient large long-range aircraft of claim 1, the fuselage contour, nose-to-tail, in a top plan form view shaped such that induced wave-drag of the left and right facing fuselages interact to cancel a portion of developed wave drag, a so-called “catamaran effect’, the outward facing fuselage surface being less curved to the atmosphere ether, thereby effecting the net drag inducing cross-sectional area equivalent.

5. What I claim as my invention is a dimensionally efficient large long-range aircraft of claim 1, with dual and fully redundant cockpits, such aircraft being capable of being flown from either fuselage, or with two pilot cabins being at the most forward location of the twin fuselages respectively, typically, pilot in left fuselage, copilot in right fuselage, with virtual camera functionality in each cabin respectively of opposite cabin visibility.

6. What I claim as my invention is a dimensionally efficient large long-range aircraft of claim 1, with consideration of growth opportunities, and for a configuration using a combined v-tail and a larger wing plan, with stability control similar to that of blended-wing configurations.
